(19) United States
(12) Patent Application Publication
(10) Pub. No.: US 2015/0100280 A1
(43) Pub. Date: Apr. 9, 2015

(54) Customized CAD Design Process

(71) Applicant: Ivoclar Vivadent, Inc., Amherst, NY (US)

(72) Inventor: Mircea D. Jula, Belle River (CA)

(73) Assignee: Ivoclar Vivadent, Inc., Amherst, NY (US)

(21) Appl. No.: 14/048,168

(22) Filed: Oct. 8, 2013

(51) Int. Cl. A61C 13/00

(52) U.S. Cl. CPC A61C 13/0004
USPC 703/1

(57) ABSTRACT

Methods and systems are disclosed for automatically generating a customized digital design of a dental restoration. The customized digital designs are generated using a set of design parameters that are specific to the dental lab ordering the restoration. As such, the resulting dental restorations require less modification by the lab and accommodate the preferences of the ordering lab.

### FIELD OF THE INVENTION

The present disclosure relates to dental restorations, and more particularly to generating digital designs for dental restorations.

### BACKGROUND OF THE INVENTION

Dental restorations for patients, for example, crowns, are commonly ordered by dentists from dental labs. Many dental labs outsource the fabrication of dental restorations to milling specialists. Traditional milling providers produce dental restorations that are specific to the fabrication process of the mill For example, a restoration ordered by a dental lab may be fabricated using design parameters which follow from the milling equipment, software design tools, worker skill, of the mill. The ordering dental lab subsequently customizes the dental restoration to suit the needs and the desired aesthetic of the lab technician. This customization is a manual process performed by the technician and requires time and effort and results in higher overall costs for creating a finished restoration.

### BRIEF SUMMARY OF THE INVENTION

The present disclosure provides a method for fabricating dental restorations that require little to no subsequent customization by a dental lab. The method advantageously incorporates one or more custom design parameters into the computer-aided design (CAD) process, and thereby automates the production of unique restorations that meet the technical and artistic requirements of the ordering dental lab.

### DESCRIPTION OF THE DRAWINGS

For a fuller understanding of the nature and objects of the invention, reference should be made to the following detailed description taken in conjunction with the accompanying drawings, in which:

FIG. 1 is a portion of a screen of a dental restoration software tool;

FIG. 2 is another portion of a screen of the dental restoration software tool of FIG. 1;

FIG. 3 is a flowchart depicting methods according to embodiments of the present disclosure; and

FIG. 4 is a diagram of a system according to the present invention.

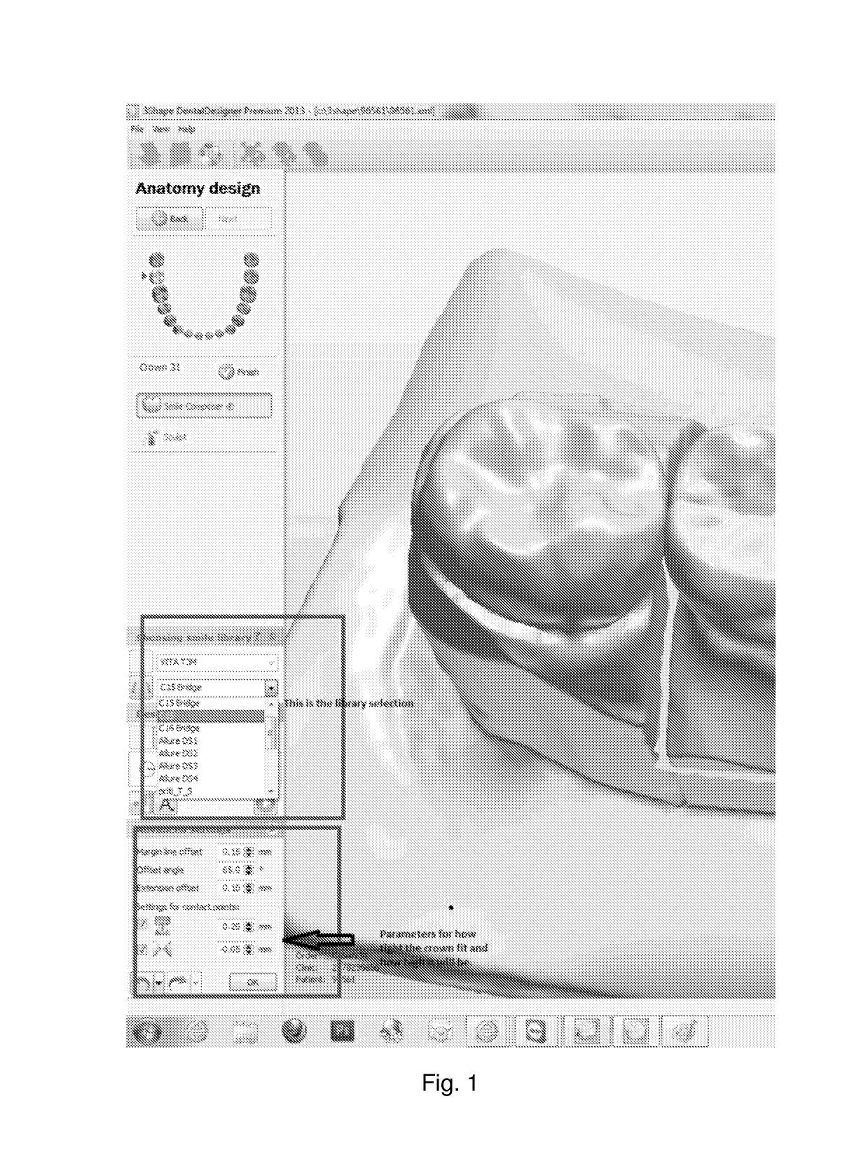

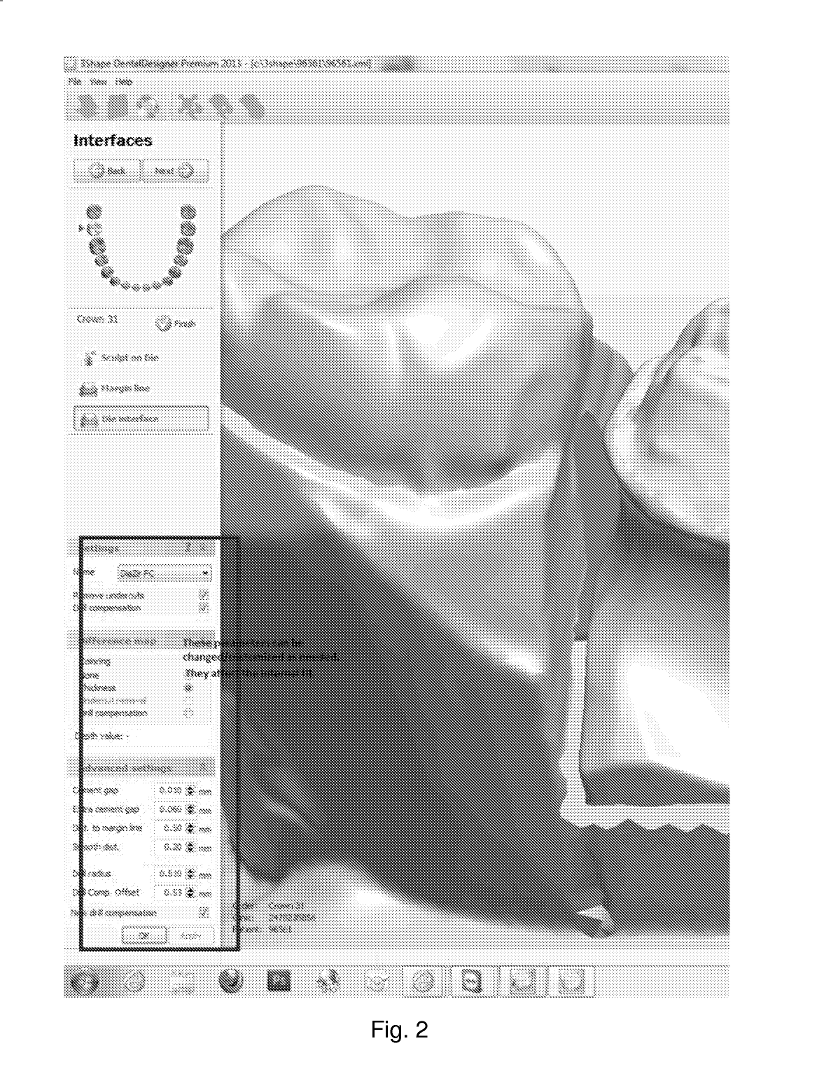

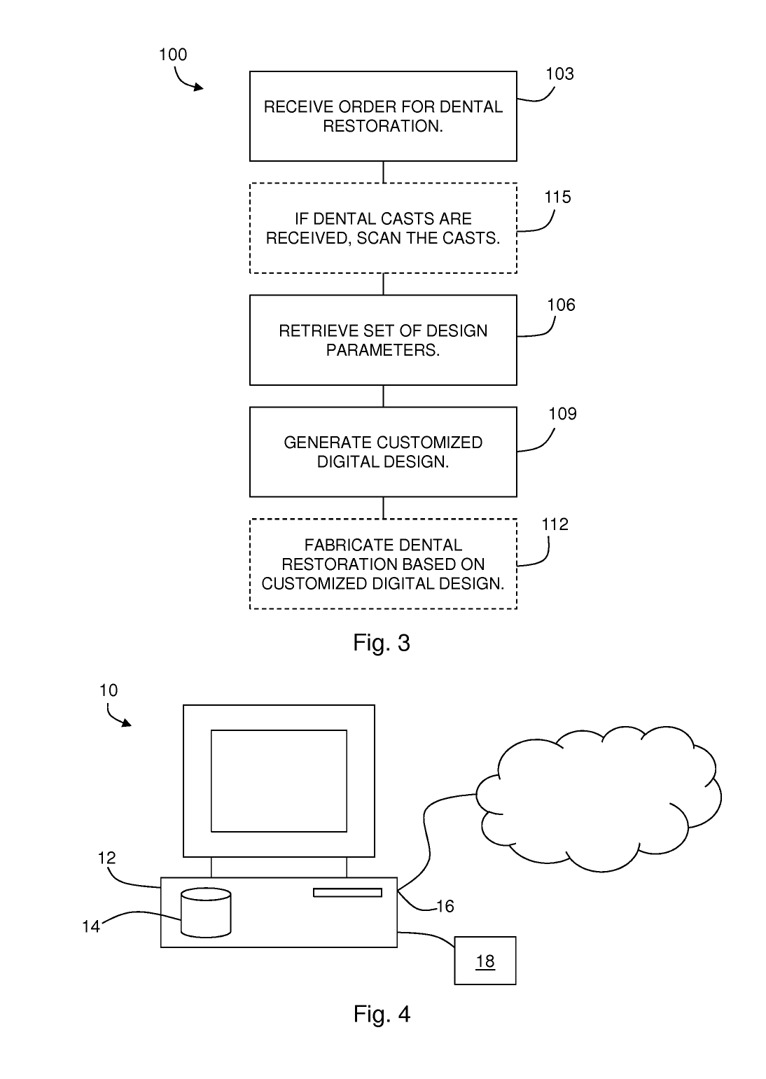

### DETAILED DESCRIPTION OF THE INVENTION

The present disclosure may be embodied as a method 100 for automatically generating a customized digital design of a dental restoration. As used in this disclosure, a customized digital design is a digital design that incorporates one or more design parameters specific to a particular dental lab. For the purposes of this disclosure, dental laboratories or labs are facilities dedicated to the manufacture or customize of a variety of dental products and medical devices to assist in the provision of oral health care by a licensed dentist. These dental products and medical devices include crowns, bridges, dentures and other dental products. Dental labs employ dental lab technicians that follow a prescription from a licensed dentist when manufacturing dental products and medical devices. In the method 100, an order for a dental restoration is received 103 from a dental lab. The order may comprise a model of a patient's dentition, such as, for example, a cast of the dentition. In other embodiments, the order may comprise a digital model of the dentition of a patient, for example, where a case is electronically scanned. In yet another embodiment, the order may comprise a digital design of a dental restoration that is not a customized digital design. Where the order comprises a dental model, the method 100 further comprises the step of scanning 115 the dental model to produce a digital model of the dentition.

A previously stored set of design parameter is retrieved 106, the set of design parameters being specific to the dental lab. The set of design parameters comprises at least one design parameter. The at least one design parameter is a library selection. Dental labs may prefer and/or otherwise utilize certain anatomical libraries. Anatomical libraries may be digital libraries of CAD designs for teeth, the designs having different appearances. The libraries may be provided by the dental lab, the miller, restoration material manufacturers, or other third-party entities. More than one library may be utilized by the dental lab and may be included in the set of design parameters.

The set of design parameters may further comprise design parameters including one or more of a base cement spacing, a surface cement spacing, a margin line distance, a drill radius/offset, a contact point value, and/or a distance to antagonist, each of which are described in more detail with reference to an exemplary dental restoration—a crown. The base cement spacing (or “cement gap”) is the amount of space needed for cement at the base of the crown. The surface cement spacing (or “extra cement gap”) is the amount of cement space applied on the surface of the preparation. The distance to margin line is the position which delimitates between the cement gap and the extra cement gap. The drill radius/offset is the space needed for a cutting tool to mill sharp corners. The contact point value is a value representing the tightness with which the crown fits between adjacent teeth. The distance to antagonist is the distance from the crown to the opposing tooth (i.e., of the opposite arch). Other design parameters will be apparent in light of the present disclosure and are included within the scope of the present methods and systems.

A customized digital design is generated 109 based on the received 103 order and the retrieved 106 design parameter. By making use of a stored set of design parameters, the generated 109 customized digital design incorporates the design preferences of the ordering dental lab and a dental restoration fabricated from the generated 109 customized digital design will require less modification by a technician.

The method 100 may further comprise the step of fabricating 112 a dental restoration based on the customized digital design. The dental restoration may be fabricated 112 using computer-aided manufacturing or other, more traditional fabrication techniques.

The present disclosure may be embodied as a system 10 for automatically generating a customized digital design of a dental restoration. The system 10 comprises a processor 12, such as, for example, a desktop computer. The processor 12 is in electronic communication with a storage device 14, such as, for example, a hard drive or a solid-state device (i.e., flash drive). The system 10 further comprises a communication interface 16. For example, the communication interface 16 may be a network interface card (“NIC”) for communicating with a computer network. In another exemplary embodiment, the communication interface 16 is an input device, for example, a CD-ROM drive. In an exemplary embodiment, a desktop computer may comprise the processor 12, storage device 14, and communication interface 16.

The processor 12 of the system 10 is programmed to receive an electronic order at the communication interface 16. For example, the communication interface 16 may be in communication with the Internet, and an electronic order may be transmitted from a dental lab, over the Internet, to the communication interface 16. The electronic order includes an electronic case. The electronic case may be, for example, a digital model of a dentition of a patient. In another embodiment, the electronic case is a digital design generated by the dental lab. The electronic order also includes a dental lab identifier. The lab identifier may be the name of the dental lab, a unique identification number assigned to the lab, or any other identifier used to uniquely identify the dental lab.

The processor 12 is further programmed to retrieve a set of design parameters from the storage device 14 using the dental lab identifier. The set of design parameters may comprises one or more design parameters such as those previously mentioned (for example, library selection, base cement spacing, surface cement spacing, margin line distance, drill radius/offset, contact point value, distance to antagonist, and/or other design parameters).

The system 10 may further comprise a scanner 18, such as, for example, a 3-dimensional scanner, suitable for scanning a dental model to produce a corresponding digital model.

The presently disclosed methods and systems provide dental labs with a completely customized dental restoration to fulfill their specific requirements of fit, anatomy, and shape. Additionally, dental restorations fabricated using the present disclosure are tailored and do not have a standardized look. As such, each dental lab feels that dental restorations produced using the customized digital designs are custom made for that lab. Also, the milling service provider can better predict the outcome of each case because of the individuality of the customized digital design.

### Examples of Establishing Design Parameters for Labs

A milling provider typically receives work from dental lab customers in three different ways (a particular lab will generally use one of the below):
Category 1: sends dental models (i.e., casts) to be scanned and designed;
Category 2: sends digital scans of the dental casts for which restorations are designed; and
Category 3: sends only an initial digital design for a restoration, where the initial digital design is created by the lab.

A set of values (i.e., design parameters) is created in order to individualize each dental lab's requirements for design and its milling parameters for dental restorations. These values may include the type of dental anatomy library to be used and other design parameters that will be adapted based on feedback from the lab until proper fit is achieved and the ideal milling strategy is selected.

This allows for each and every lab to receive a restoration incorporating their own preferences regarding anatomy used, fit parameters, inter-proximal contacts and occlusal clearance.

### Process Description

(1) the dental lab contacts the milling provider;
(2) a customer care associate of the milling provider opens an account and explains the business model, products, and product turn-around time to the lab contact;
(3) a technical support associate of the milling provider connects with the lab and, based on the lab's methods, one of three processes follows:

If the lab sends models to the service provider (i.e., category 1 as described above):
(a) trial digital designs are produced using a validated (default) set of design parameters that are known to work with the processes and systems of the milling provider;
(b) a CAD coordinator contacts the dental lab to discuss the trial designs, and the Cad Design coordinator modifies the design parameters to accommodate the lab's feedback;
(c) a specific tooth library is selected with the dental lab, based on their preferences, and added to the stored design parameters for the lab;
(d) additional trial cases are produced using the stored design parameters and the additional trials are evaluated with the customer (i.e., dental lab);
(e) steps (c) and (d) are repeated until the produced designs are satisfactory to the customer (i.e., dental lab); and
(f) the stored design parameters are saved for use with future cases received from the dental lab.

If the lab sends digital scans to the service provider for processing (i.e., category 2):
(a) a technical support associate remotely connects to the dental lab's scanning system and uploads data specific to the milling provider into the scanning system;
(b) a specific tooth library is selected with the lab, based on the lab's preferences, and the library is stored within a set of design parameters for the lab;
(c) trial digital designs are produced based on scans submitted by the dental lab and using the set of stored design parameters, and the designs are evaluated;
(d) the stored design parameters are refined based on the results of the evaluation; and additional trial cases are produced; additional changes are implemented as needed until dental lab's requests are met; and
(e) the stored design parameters are saved for use with future cases received from the lab.

If the lab sends digital designs (i.e., category 3):
(a) a CAD coordinator implements—via remote connection—the validated (default) set of design parameters into the dental lab's system;
(b) a specific tooth library is selected with the lab, based on their preference, and added to the stored design parameters;
(c) the lab scans and designs trial cases based on the set of design parameters and sends the trial digital designs to the milling provider for manufacturing;
(d) a follow up call is made and, based on feedback received from the lab, the CAD coordinator will make any necessary changes in the customer's system by modifying the stored set of design parameters; and
(e) the stored design parameters are saved for use with future cases generated by the lab and sent to the milling provider for fabrication.

Although the present invention has been described with respect to one or more particular embodiments, it will be understood that other embodiments of the present invention may be made without departing from the spirit and scope of the present invention.

What is claimed is:

1. A computer-based method for automated generation of a customized digital design of a dental restoration, the method comprising the steps of:
receiving an order for a dental restoration from a dental lab;
electronically retrieving a stored set of design parameters for the dental lab; the set of design parameters comprising a library selection; and
generating a customized digital design for the dental restoration based on the order and the retrieved design parameters.

2. The method of claim 1, further comprising the step of fabricating the dental restoration based on the customized digital design.

3. The method of claim 1, wherein the received order comprises a dental model of a dentition, and the method further comprises the step of scanning the dental model to produce a digital model of the dentition.

4. The method of claim 1, wherein the received order comprises a digital model of a dentition.

5. The method of claim 1, wherein the received order comprises a default digital design for the dental restoration.

6. The method of claim 1, wherein the stored set of design parameters further comprises at least one of a base cement spacing, a cement gap, a margin line distance, a drill offset, a contact point parameter, and a distance to antagonist.

7. A system for automatically generating a customized digital design of a dental restoration, comprising:
a processor;
a storage device in electronic communication with the processor;
a communication interface in electronic communication with the processor;
wherein the processor is programmed to:
receive an electronic order for a dental restoration at the communication interface, wherein the electronic order includes a dental lab identifier and an electronic case;
retrieve a stored set of design parameters from the storage device using the dental lab identifier;
generate a customized digital design for the dental restoration based on the electronic case and the retrieved set of design parameters; and
store the generated customized digital design on the storage device.

8. The system of claim 7, wherein the electronic case includes a digital model of a dentition.

9. The system of claim 7, wherein the electronic case includes a default digital design.

10. A method for generating a set of customized computer-aided design of dental restorations, comprising the steps of:
receiving an order for a dental restoration from a lab;
producing the dental restoration based on default design parameters, wherein the default design parameters comprise a default library selection;
receiving design changes from the lab;
storing custom design parameters associated with the received design changes, wherein the custom design parameters comprise a custom library selection; and
producing a dental restoration based on the custom design parameters.

11. The method of claim 10, wherein receiving an order for a dental restoration comprises the sub-step of receiving a dental model of a dentition.

12. The method of claim 10, wherein receiving an order for a dental restoration comprises the sub-step of receiving an electronic scan of a model of a dentition.

13. The method of claim 10, wherein receiving an order for a dental restoration comprises the sub-step of receiving a digital design of the dental restoration.

14. The method of claim 10, wherein the custom design parameters further comprise at least one of a base cement spacing, a cement gap, a margin line distance, a drill offset, a contact point parameter, and a distance to antagonist.
